(19) United States
(12) Patent Application Publication
(10) Pub. No.: US 2014/0339808 A1
(43) Pub. Date: Nov. 20, 2014

(54) DOCUMENT CONTAINING UV ABSORBING SECURITY MARK

(71) Applicants: Thomas D. Pawlik, Rochester, NY (US); Judith A. Bose, Webster, NY (US)

(72) Inventors: Thomas D. Pawlik, Rochester, NY (US); Judith A. Bose, Webster, NY (US)

(21) Appl. No.: 13/896,610

(22) Filed: May 17, 2013

(51) Int. Cl. B42D 15/00

(52) U.S. Cl. CPC B42D 15/0026
USPC 283/85

(57) ABSTRACT

A document with a security marker includes a substrate comprising an optical brightener; a background comprising an ultraviolet (UV) absorbing material arranged in a first pattern of lines having a first frequency and a first orientation; and a security mark comprising the UV material arranged in a second pattern of lines having a second frequency and a second orientation.

### CROSS REFERENCE TO RELATED APPLICATIONS

Reference is made to commonly-assigned copending U.S. patent application Ser. No.______ (Attorney Docket No. K001526US01NAB), filed herewith, entitled SYSTEM FOR AUTHENTICATING UV ABSORBING SECURITY MARK, by Pawlik et al.; and U.S. patent application Ser. No. ______(Attorney Docket No. K001321US01NAB), filed herewith, entitled METHOD FOR AUTHENTICATING UV ABSORBING SECURITY MARK, by Pawlik et al.; the disclosures of which are incorporated herein.

### FIELD OF THE INVENTION

This invention relates to security markers.

### BACKGROUND OF THE INVENTION

Ultraviolet (UV) fluorescing marks are a common covert security feature used to authenticate items, documents and printed materials and are used to combat counterfeiting. The most common UV fluorescent inks available in the market are blue emitting. Typically they are compounds similar to optical brighteners used in print media. As a result, such inks cannot be used in combination with printing media containing optical brighteners. Most office papers, for example, contain such brighteners. Alternatives to blue emitters are green or red UV fluorescing molecules. While these can be used in combination with optically brightened substrates, they contain rare earth metals, are more expensive and less light stable. Green or red fluorescing pigments are often inorganic particles and are often not stable in low viscosity inks, e.g. inkjet, because of their high specific weight.

An alternative solution for printing hidden indicia on an optically brightened substrate is to print with a UV absorbing material instead of a UV fluorescing material. Such compounds are available from BASF under the trade name Tinuvin. While most examples of Tinuvin require organic (co-) solvents, there are water-based nanoparticle dispersions available, for example Tinuvin 99-DW (clear) or Tinuvin 477-DW (slight yellow). When the indicia are printed imagewise on the optically brightened medium using the UV absorbing ink, the hidden information is revealed in an attenuated form (darker vs. background) under UV illumination because the effect of the optical brightener is attenuated by the UV absorber. The contrast between image and background in this system is often less than is seen for UV fluorescing inks printed on neutral media, thus making the UV absorber on optically brightened substrate a more subtle covert mark, which is desirable. There is no characteristic “glow” of a UV fluorescing ink. This makes the mark less conspicuous to cursory investigation.

The information printed with UV ink can be alphanumeric text, a barcode, a logo, or a picture. It can also be a lenticular hidden image that requires a lenticular screen for revealing additional information under UV illumination. This can be useful because it is a common practice for counterfeiters to inspect items, documents, and printed materials with UV illumination to find hidden information. Once found, the information (e.g. a code) can be replicated on counterfeit product to make it appear to be genuine.

In general, requiring the use of a lenticular screen increases the level of security because it makes the covert mark more difficult to replicate. However, if a lenticular hidden image is printed with UV-green or UV-red fluorescing ink (UV-blue is impractical because of the optical brighteners), the presence of the security feature is easily revealed by the green or red glow under UV illumination even without a decoding lenticular lens. This alerts counterfeiters to the location of the security feature and encourages further analysis.

It is therefore highly desirable to have a system that allows covert embedding of information on optically brightened substrates, is subtle and difficult to detect by cursory investigation with UV illumination, and is difficult to decode even if located.

### SUMMARY OF THE INVENTION

Briefly, according to one aspect of the present invention, a document with a security marker includes a substrate comprising an optical brightener; a background comprising an ultraviolet (UV) absorbing material arranged in a first pattern of lines having a first frequency and a first orientation; and a security mark comprising the UV material arranged in a second pattern of lines having a second frequency and a second orientation. The printing is done using an ultraviolet (UV) absorbing material. The security mark and background that are printed are line patterns with distinct phase, frequency and orientation. The hidden information is detected by using UV illumination in conjunction with a lenticular screen or other device that is capable of detecting the differences between the line patterns of the background and the line patterns of the image, such as a digital image capture device with an image analysis algorithm. Printing with a UV absorbing ink on an optically brightened substrate allows covert information to be printed that is invisible to the unaided eye. Additionally, the UV absorber ink is a less conspicuous under UV illumination than a green or red UV fluorescing ink would be and as a result in a cursory investigation of the document the printed area may not be apparent. Printing the information using line patterns as a means of creating the difference between background and image adds a level of security since a lenticular screen or other method of detection of the line patterns is required to distinguish the image from the background. The phase, frequency and orientation are chosen such that without the use of a lenticular screen or other such device, no image is apparent to the viewer. Should the general area be detected, recognition of what is printed is not possible without the lenticular screen. Only a person that has advance knowledge of the security feature and uses the appropriate lenticular screen in combination with UV illumination would be able to reveal the security feature.

In one embodiment, an optically brightened substrate is printed with UV absorbing ink and the image and background are comprised of line patterns wherein the orientation of the printed lines comprising the background of the image is different from the lines that comprise the image. The phase and the frequency of the lines in both the background and the image are the same. The hidden image is detected with the use of UV illumination in combination with a lenticular screen. The lenticular screen can be a lens or other device that is capable of detecting the differences between the line patterns of the background and the line patterns of the image, such as a digital image capture device with an image analysis algorithm. Authentication of a document is achieved when the revealed hidden image is confirmed by the investigator.

In a second embodiment, an optically brightened substrate is printed with UV absorbing ink. The image and background are comprised of line patterns where the frequency of the printed lines comprising the background of the image is different from the lines that comprise the image. The phase and the orientation of the lines in both the background and the image are the same. The hidden image is detected with the use of UV illumination in combination with a lenticular screen. The lenticular screen can be a lens or other device that is capable of detecting the differences between the line patterns of the background and the line patterns of the image, such as a digital image capture device with an image analysis algorithm.

In a third embodiment, an optically brightened substrate is printed with UV absorbing ink. The image and background are comprised of line patterns wherein the phase of the printed lines comprising the background of the image is different from the lines that comprise the image. The orientation and the frequency of the lines in both the background and the image are the same. The hidden image is detected with the use of UV illumination in combination with a lenticular screen. The lenticular screen can be a lens or other device that is capable of detecting the differences between the line patterns of the background and the line patterns of the image, such as a digital image capture device with an image analysis algorithm.

If the printing media contains no optical brighteners the hidden information can still be revealed using a UV sensitive camera. In this case the hidden information is visible because of the reduction of UV reflection from the substrate.

The invention and its objects and advantages will become more apparent in the detailed description of the preferred embodiment presented below.

### BRIEF DESCRIPTION OF THE DRAWINGS

FIG. 1 is a schematic showing identification of hidden information with UV absorbing inks on optically brightened substrate.

FIG. 2 is a schematic of an image created by line patterns that differ in orientation between the image and the background.

FIG. 3 is a schematic of an image created by line patterns that differ in frequency between the image and the background.

FIG. 4 is a schematic of an image created by line patterns that differ in phase between the image and the background.

FIG. 5 is a schematic showing identification of hidden information with UV absorbing inks on optically brightened substrate with an image capture device.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

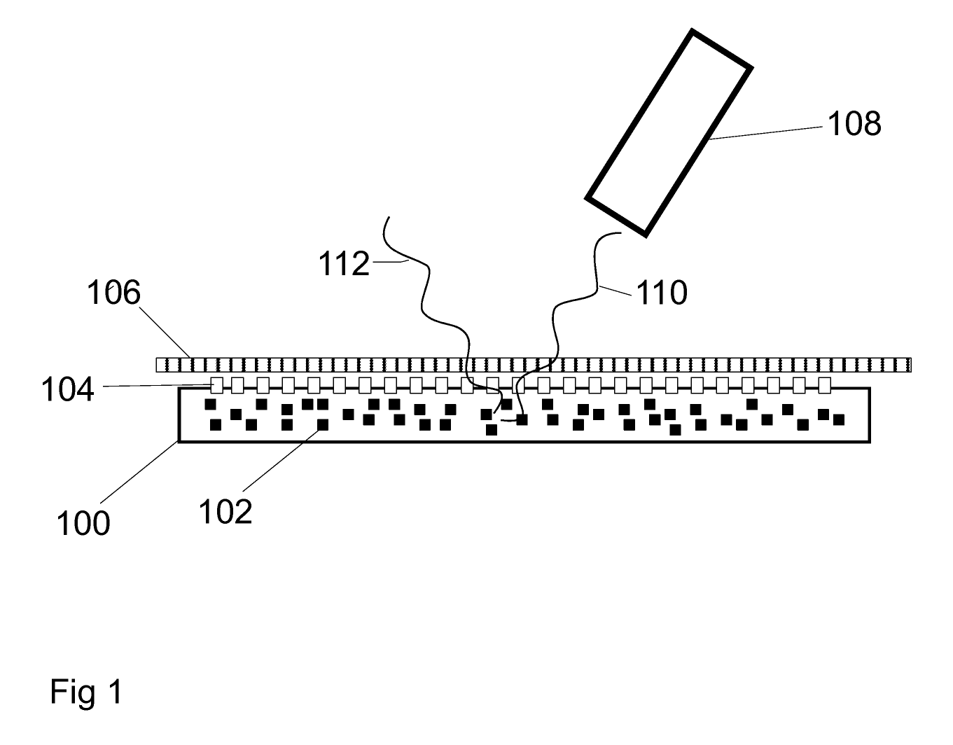

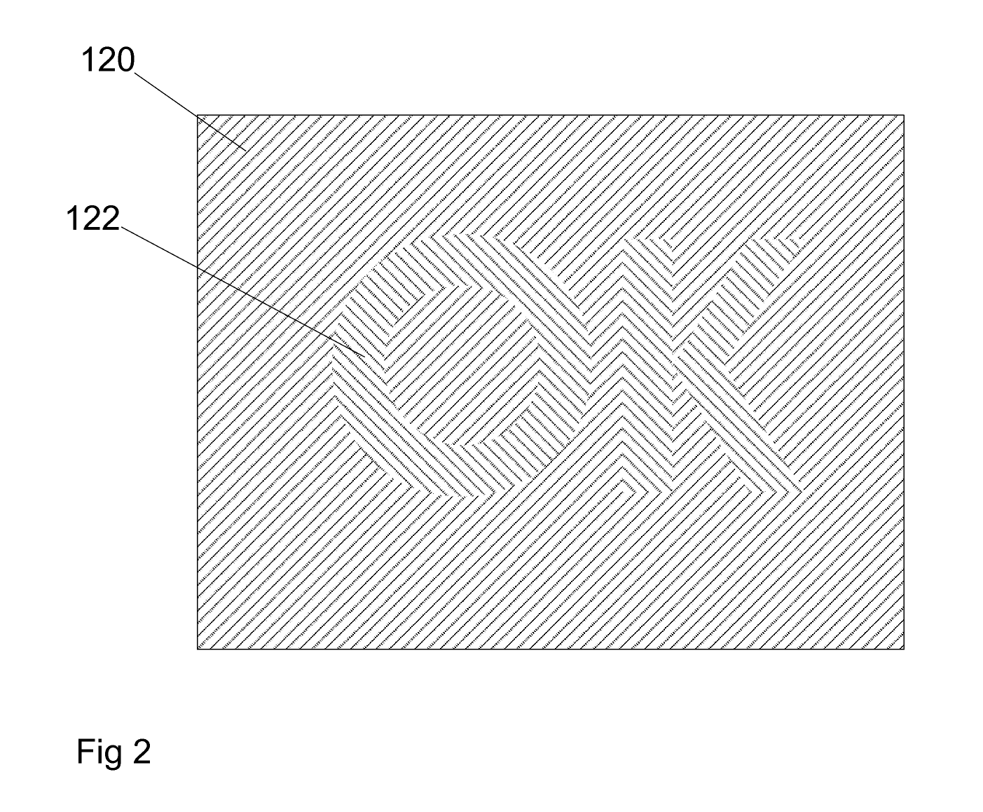

Referring now to FIG. 1, a substrate 100 contains optical brightener 102. Optical brighteners are fluorescent chemical compounds that convert long ultraviolet radiation (UV) to blue radiation and make the substrate appear brighter. Most office paper contains optical brighteners. A typical chemical used for this purpose is 2,5-Bis(5-tent-butyl-benzoxazol-2-yl) thiophene. A halftone image with embedded hidden indicia is printed onto the substrate using an ink that contains a UV absorbing material 104. The image artwork is shown in subsequent FIGS. 2-4.

In order to reveal the hidden indicia a lenticular lens or screen 106 is placed in contact with the substrate. A UV illuminator 108 irradiates the substrate with UV radiation 110, preferably through the lenticular lens 106. The lens itself is transparent to the UV radiation. The substrate and areas where no UV absorber is printed it will irradiate the optical brighteners. In areas where UV absorber is present the UV radiation will be attenuated and therefore the optical brighteners in that area will be irradiated to a lesser degree. The UV radiation reaching the optical brighteners will be converted to visible (blue) radiation 112 which will transmitted through the lenticular lens and be viewed by the operator performing the authentication. The correct placement of the lenticular lens will create an aliasing effect that will make the security mark appear as an area of different brightness with respect to the background.

FIG. 2 shows one embodiment of the halftone image with a security mark. The background 120 is printed as a first regular pattern of lines with a first orientation. The security mark is printed using a second regular pattern of lines with a second orientation 122. Phase and frequency of the two line patterns are identical. In the embodiment shown the background does not show through the security marks. In other words the background does not extend under the security mark. The security mark and background are printed in adjacent (mutually exclusive) areas such that the background does not “shine through” the security mark.

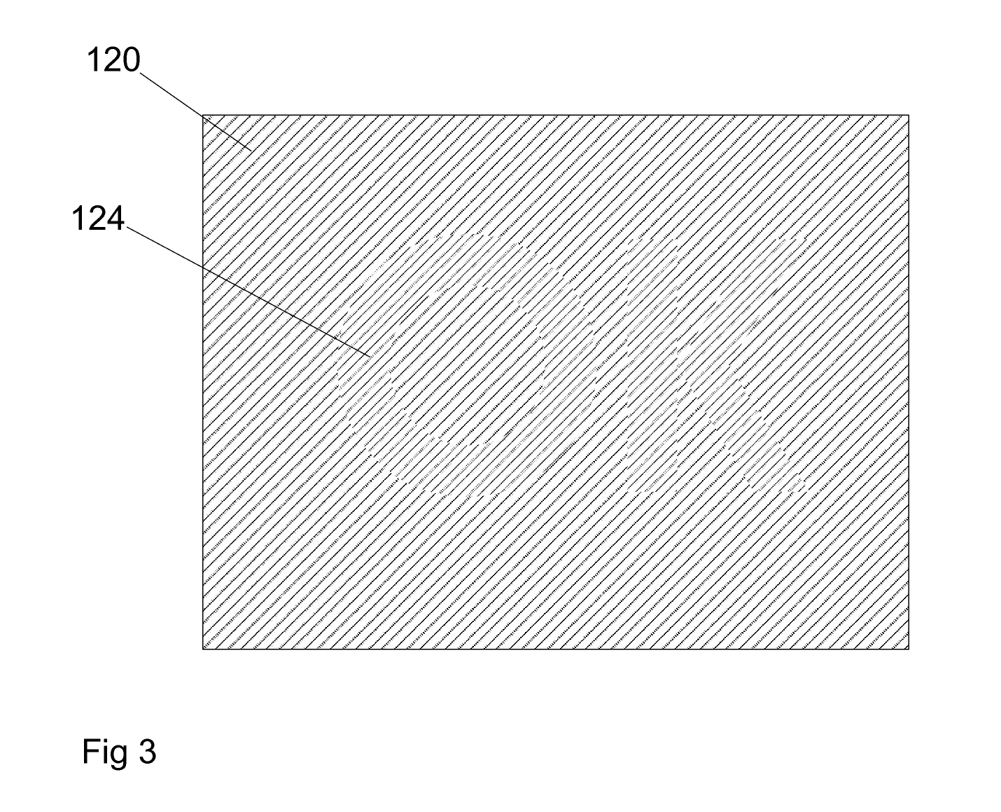

FIG. 3 shows a second embodiment of the halftone image with a security mark. The background 120 is printed as a first regular pattern of lines with a first frequency. The security mark is printed using a second regular pattern of lines with a second frequency 124. Phase and orientation of the two line patterns are identical.

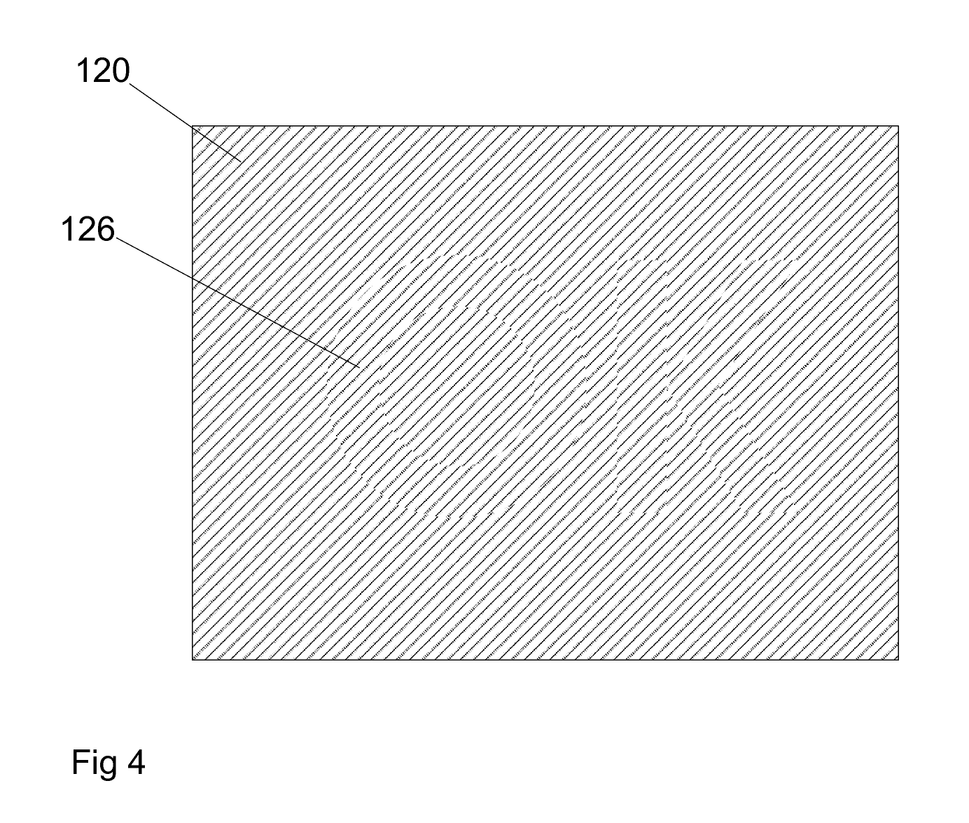

FIG. 4 shows a third embodiment of the halftone image with a security mark. The background 120 is printed as a first regular pattern of lines with a first phase. The security mark is printed using a second regular pattern of lines with a second phase 126. Frequency and orientation of the two line patterns are identical.

The line frequencies should be high enough such that in the absence of a lenticular lens, they will only resemble an unstructured image to the unaided eye under UV illumination. Correct placement of the lenticular lens will create aliasing effects that will make the security mark visible. In order to achieve the aliasing effects, the frequency of the lenticular lens should be either equal to the frequency of one of the line patterns or be a multiple or integer fraction. The orientation of the lenticular lens should match the orientation of one of the line patterns.

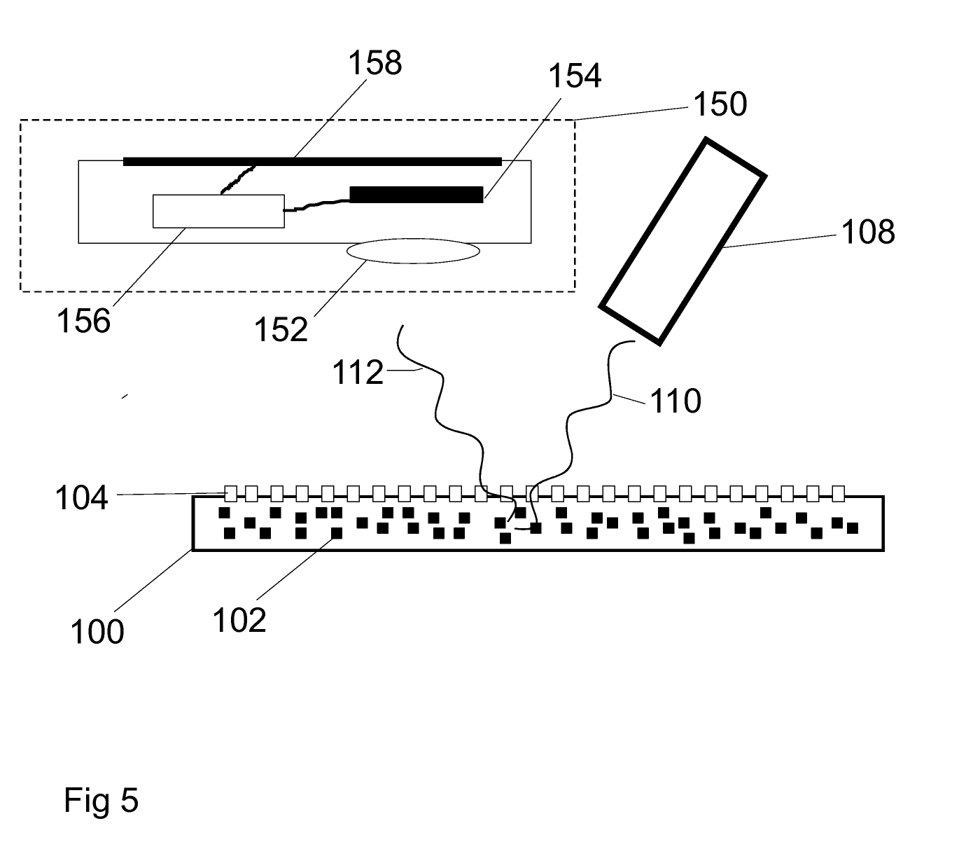

FIG. 5 shows an alternative process to make the security mark visible. The lenticular lens (106 in FIG. 1) is replaced by an image capture device 150 that comprises a lens 152 which focuses the image of the security mark onto an image sensor 154. The captured image is processed in a microprocessor 156 which applies an image transformation such as computing the image gradient using a Sobel operator. The transformed image is displayed on the display 158. This image will show the security mark which is otherwise invisible to the naked eye. Using an image capture device to reveal the security mark is advantaged over using a lenticular lens when the security mark is printed on a curved surface such as a bottle label. Optionally, other preceding or subsequent image transformations such as color transformations, grayscale conversions and generation of a false color image can be used to improve the visibility of the security mark.

The invention has been described in detail with particular reference to certain preferred embodiments thereof, but it will be understood that variations and modifications can be effected within the scope of the invention. For example, the line described above may be comprised of dots rather than solid lines.

### PARTS LIST

100 substrate

102 optical brightener

104 ink containing UV absorbing material

106 lenticular lens

108 ultraviolet (UV) light

110 ultraviolet (UV) radiation

112 visible radiation

120 background comprising first pattern of lines

122 security mark comprising second pattern of lines with different orientation

124 security mark comprising second pattern of lines with different frequency

126 security mark comprising second pattern of lines with different phase

150 image capture device

152 lens

154 image sensor

156 microprocessor and memory

158 display

1. A document with a security marker comprising:
a substrate comprising an optical brightener;
a background comprising an ultraviolet (UV) absorbing material arranged in a first pattern of lines having a first frequency and a first orientation; and
a security mark comprising the UV material arranged in a second pattern of lines having a second frequency and a second orientation.

2. The document of claim 1 wherein the predetermined security mark is selected from a group consisting of an image, a logo, a series of numbers or letters or both, a bar code, or a hash tag.

3. The document of claim 1 wherein the first orientation differs from the second orientation by at least 10 degrees.

4. The document of claim 1 wherein the orientation of a lenticular lens differs from either the first orientation or the second orientation by less than 5 degrees.

5. The document of claim 1 wherein the first frequency is equal to the second frequency.

6. The document of claim 1 wherein the first orientation is equal to the second orientation and the first and second frequencies are different.

7. The document of claim 1 wherein UV illumination directed at the security marker and a lenticular lens is used to authenticate the security mark.

8. The document of claim 1 wherein the frequency of the lenticular lens is a multiple of the first or second frequency.

9. The document of claim 7 wherein the frequency of the lenticular lens is equal to the first or second frequency.

10. The document of claim 7 wherein the authentication is a visual match with a predetermined security mark.

11. The document of claim 1 wherein an image capture device UV illumination directed at the security marker is used to authenticate the security mark.
